(19) United States
(12) Patent Application Publication
(10) Pub. No.: US 2025/0206098 A1
(43) Pub. Date: Jun. 26, 2025

(54) ACTUATOR DEVICE FOR A MOTOR VEHICLE

(71) Applicant: ZF Friedrichshafen AG, Friedrichshafen (DE)

(72) Inventor: Peter Hofmann, Gilching (DE)

(73) Assignee: ZF Friedrichshafen AG, Friedrichshafen (DE)

(21) Appl. No.: 18/849,809

(22) PCT Filed: Jan. 18, 2023
(86) PCT No.: PCT/EP2023/051084

§ 371 Date: Sep. 23, 2024

(30) Foreign Application Priority Data
Mar. 24, 2022 (DE) 10 2022 202 908.9

(51) Int. Cl. B60G 21/055; F16C 33/78; F16J 15/34

(52) U.S. Cl. CPC B60G 21/0555; F16C 33/7879; F16J 15/3456; B60G 2206/427; F16C 2326/05

(57) ABSTRACT

An actuator device (2) for a motor vehicle, in particular for a roll stabilizer of a motor vehicle, having a housing (6) and a drive output element (9) mounted to rotate relative to the housing about a rotation axis (11). Associated with the drive output element (9) is a seal (12) for sealing an inside space (24) of the housing (6) relative to an external environment (25). Associated with the drive output element (9) is an annular inner sealing element (20) and associated with the housing (6) is an annular outer sealing element (30). In an axial projection, the sealing elements (20, 30) partially overlap and are in contact so as to form at least one all-round sealing area (33a, 33b, 33c, 34a, 34b; 35a, 35b, 35c, 36).

### RELATED APPLICATIONS

This application claims the benefit under 35 U.S.C. § 371 as a U.S. National Phase Application of application no. PCT/EP2023/051084, filed on 18 Jan. 2023, and which claims the benefit of German Patent Application no. 10 2022 202 908.9 filed on 24 Mar. 2022, the contents of which are hereby incorporated herein by reference in their entireties.

### FIELD OF THE DISCLOSURE

The invention relates to an actuator device for a motor vehicle, in particular for a roll stabilizer of a motor vehicle. Furthermore, the invention relates to a seal for an actuator device for a motor vehicle.

### BACKGROUND

From automotive technology, in particular chassis technology, it is known to influence the roll or rolling behavior of motor vehicles by means of roll stabilizers. The basic structure of these is an essentially a C-shaped torsion bar which is mounted in a central area so that it can rotate relative to the vehicle body and whose opposite outer ends are each connected via a coupling element, a so-termed pendulum support, to a wheel suspension. By virtue of that design, it is ensured that when driving round a curve, the body of the vehicle not only sinks on the outer side of the curve (owing to the centrifugal force), but also that the wheel on the inside of the curve is lowered to some extent. Roll stabilizers improve the track maintenance of the vehicle and reduce the sideways tilting of the vehicle body (rolling), making the driving round curves safer and more comfortable.

To increase the vehicle stability and driving comfort still more, it is known to make such roll stabilizers adjustable. The roll stabilizer then comprises an actuator device and, for example, is divided into two stabilizer sections which, with the help of the actuator, can be rotated relative to one another about a rotation axis. By rotating the stabilizer sections relative to one another, a controlled rolling movement of the vehicle body is produced, or a rolling movement of the vehicle body caused by external influences, is counteracted in a controlled manner. From the prior art, adjustable roll stabilizers are known and whose actuator device comprises an electric motor which, to produce suitable rotation speeds or torques, is drivingly connected with a mechanical gear system especially in the structural form of a multi-stage planetary gear system. In this connection, reference should be made as a general example to DE 10 2016 219 399 A1.

Actuator devices operated in a vehicle can be exposed to humid weathering conditions such as rain, or moisture in general. For a mechanical system such as an actuator device there is a risk that moisture can penetrate into the housing of the actuator device and compromise the function of components or permanently damage them. Accordingly, it is very important to provide a reliable and long-lasting seal of the inside space of the housing against the external environment of the actuator device. An actuator device with a seal to seal the inside space of the housing is known from DE 10 2020 208 851 A1.

In actuator devices known from the prior art, during operational use-influenced by mechanical loads, the installation situation, the design of the actuator device (in most cases a multi-stage planetary gear system which is driven by an electric motor at different speeds, different torques and frequent changes of the rotation direction)—besides the pure rotation of the drive output element abut its rotation axis other movements of the drive output element relative to the housing also take place (displacements in the axial direction, displacements in the radial direction, caused for example by transverse forces acting as a whole upon the actuator device) and/or rotational movements (rotation about a rotation axis perpendicular to the main rotation axis, caused for example by bending forces).

All movements of the drive output element that differ from its (pure) rotation about its rotation axis have in common that the geometrical proportions are changed, in particular the distances between the drive output element and the housing. In the case of known sealing concepts from the prior art, in which the main seal used is a radial shaft sealing ring whose sealing lips form a radial seal relative to a working envelope surface of the drive output element, these movements can easily result in leaking of the seal, which is disadvantageous.

### SUMMARY

A purpose of the present invention is to indicate an actuator device for a motor vehicle, of the type mentioned at the beginning, which overcomes these disadvantages; in particular, an actuator device is provided which can be trusted to remain leakproof even when operation-induced movements of the drive output element take place that deviate from a pure rotation about the main rotation axis, and which is therefore more robust. In addition, a corresponding seal is provided.

This objective is achieved in the first place by an actuator device having the features disclosed herein. This is an actuator for a motor vehicle, in particular for a roll stabilizer of a motor vehicle, which comprises a housing and on the other hand a drive output element mounted to rotate about a rotation axis, which in particular is suitable for forming a stabilizer section of the roll stabilizer. Associated with the drive output element is a seal for sealing an inside space of the housing against an external environment. According to the invention, the actuator device is characterized in that an annular inner sealing element is associated with the drive output element and an annular outer sealing element is associated with the housing, such that the sealing elements partially overlap in an axial projection and are in contact to form at least one all-round sealing area.

The invention is based on the recognition that actuator devices known from the prior art are conventionally fitted with a seal on the drive output element, which is in the form of a radial shaft seal. To achieve the requisite sealing action, such seals need to be exactly concentric between the shaft (the drive output element) and the housing. Accordingly, due to external force or torque influences which give rise to deformations between the drive output element and the housing, the seal can only react to a limited extent, if at all. Then, despite some prestressing in the seal system, leaking can easily take place, which in turn can result in destruction or at least considerable curtailment of the useful life of the actuator device. Since, according to the invention, annular sealing elements are associated with both the drive output element and the housing, which seals partially overlap in an axial projection and are in mutual contact, forming at least one all-round sealing area, a seal is provided that acts in the axial direction. In this case, as viewed in the axial direction the at least one all-round sealing area is located between the sealing elements. By virtue of the axial sealing principle, this has the advantage that even if the drive output element adopts an eccentric position, i.e., a position that deviates from centricity relative to the housing, the desired sealing action can still be ensured. Accordingly, the actuator device has improved concentric insensitivity as regards its sealing system. This design enables simple assembly and weighs very little.

In a preferred version of the actuator device, its seal is designed in such manner that in the all-round sealing area the sealing elements (of the drive output element and the housing) exert a sealing force on one another that acts in the axial direction. This can be done in various ways.

Advantageously, one of the sealing elements has an annular sealing surface that extends in the radial direction. This design makes it possible for the sealing area formed by the contact between the two sealing elements to vary its position, at least within limits, whereby certain positional inaccuracies of the drive output element can be compensated.

In a preferred further development of the actuator device, the sealing force is produced by a prestress applied by partial deformation of one of the sealing elements. In other words, in the fitted state one of the sealing elements is at least partially deformed so that the restoring force produced thereby prestresses the sealing system.

According to the invention it is provided that the sealing elements are in contact in at least one all-round sealing area. To achieve an enhanced sealing action, it is advantageously provided that the sealing elements are in contact in more than one circumferential sealing area. The presence of a plurality of sealing areas makes it more difficult for any medium to get through, since in order to be able to get into the inside space of the housing, the medium concerned has to overcome not just one, but however many of the sealing areas are formed.

In a preferred embodiment of the actuator device, either the outer sealing element or the inner sealing element forms an all-round groove into which the respective other sealing element, i.e., either the inner or the outer sealing element projects radially in part, in particular engaging in the groove. In that way, with simply designed means a seal is provided which can act on several sides and/or sealing areas, by virtue of which various advantages still to be explained can be achieved. Thanks to the presence of a groove into which the respective other sealing element partially projects, in particular engaging therein, in a simply designed manner a labyrinth seal is provided which can effectively prevent the entry of a medium. Various designs in accordance with this principle are conceivable.

In a preferred embodiment, the sealing element that forms the circumferential groove has two sealing surfaces spaced axially a distance apart and parallel to one another. Correspondingly, the respectively “other sealing element” projects radially partially into an area of the groove located between the mutually parallel sealing surfaces. It is understood that this type of design of the seal can enable some radial movement of one sealing element relative to the other sealing element—at least within certain limits.

An enhanced sealing action can be achieved if the sealing element that forms the all-round groove contacts the other sealing element, i.e., the one that projects partially into the all-round groove, axially on both sides so as to form a plurality of sealing areas. The presence of several sealing areas makes the entry of a medium more difficult. In addition, in an advantageous manner axial contact on both sides of the sealing element projecting into the sealing element that forms the groove balances out the forces and thus in the ideal case eliminates the forces acting in the axial direction, so that despite the prestress prevailing in the sealing system the sealing elements are force-free relative to the housing and the drive output element.

As regards the further design of a sealing element with a circumferential groove, an advantageous further development of the invention provides that a sealing element comprises two axially adjacent annular bodies with their axes arranged to be coincident with the rotation axis, which are shaped in such manner that an annular space forming the circumferential groove is formed between them. Correspondingly, the sealing element concerned could be made in two parts, namely of two annular bodies.

To enable easy assembly, in an advantageous further development of the actuator device the two annular bodies that form a sealing element are advantageously connected to one another, in particular with interlock or by friction force, or particularly preferably clipped one to the other.

Simple and inexpensive production can be achieved if the annular bodies are identical or at least similar components, which relative to a radial plane of separation are orientated in mirror-symmetrical relationship with one another.

To perform their function, the sealing elements used in the context of the invention can be designed differently and made from different materials. A preferred further development of the invention provides that the sealing element partially held in the circumferential groove is made from an elastic material, preferably an elastomeric plastic.

Advantageously, the sealing element held partially in the circumferential groove has an undulating shape in relation to its radial extension, in particular such that at each undulation peak it forms an all-round sealing area particularly in the contact zone with the other sealing element.

Advantageously, axially on both sides of the sealing element held partially in the circumferential groove there are about the same number of all-round sealing areas. Such a design can in particular be achieved if the corresponding sealing element has an undulating shape in relation to its radial extension, as described above. With the presence of about the same number of sealing areas axially on both sides, in an advantageous manner a plurality of sealing areas and a force equilibrium in the axial direction can be produced, so that the sealing forces acting between the sealing elements are eliminated and accordingly no forces of reaction act upon the housing or the drive output element.

Alternatively, or in addition to an undulating shape, it can be provided that at least one preferably all-round ridge is formed on the sealing element which is held partially in the circumferential groove. For example, one or more such ridges can serve to form an all-round sealing zone. In such a case the all-round ridge contacts the sealing element in which the groove is formed so that if the ridge is appropriately designed, then when assembled, it is prestressed so as to apply the respectively necessary sealing force by virtue of its deformation.

The present invention is used for an actuator for a motor vehicle, in particular for a roll stabilizer of a motor vehicle. According to a preferred design of the actuator device, the housing has a basically cylindrical shape and accommodates a drive unit comprising in particular an electric motor and a multi-stage planetary gear system which unit can be brought into driving connection with the drive output element.

The objective stated to begin with is further achieved by a seal having the characteristics disclosed herein. This is a seal for an actuator device for a motor vehicle, in particular an actuator device of the type described above. According to the invention the seal comprises: an annular outer sealing element on the housing side and an annular inner sealing element on the drive output side, such that the sealing elements are arranged coaxially relative to a rotation axis of a drive output element of the actuator device, and such that they overlap partially in an axial projection, and such that they are in contact, forming at least one all-round sealing area. The seal according to the invention advantageously has further features which have already been described in connection with the actuator device itself. To avoid repetition, further related explanations will therefore be omitted.

### BRIEF DESCRIPTION OF THE DRAWINGS

Below, the invention is explained in greater detail with reference to a drawing. From this, further design options and advantageous effects of the invention emerge. The drawing shows:

FIG. 1: A schematic perspective view of an adjustable roll stabilizer,

FIG. 2: A simplified sectional view of an actuator device of an adjustable roll stabilizer,

FIG. 3: A partially sectioned representation of a seal according to an example embodiment of the invention,

FIG. 4: Part of the seal in FIG. 3, viewed axially from above,

FIG. 5: A partially sectioned representation of a seal according to another example embodiment of the invention.

### DETAILED DESCRIPTION

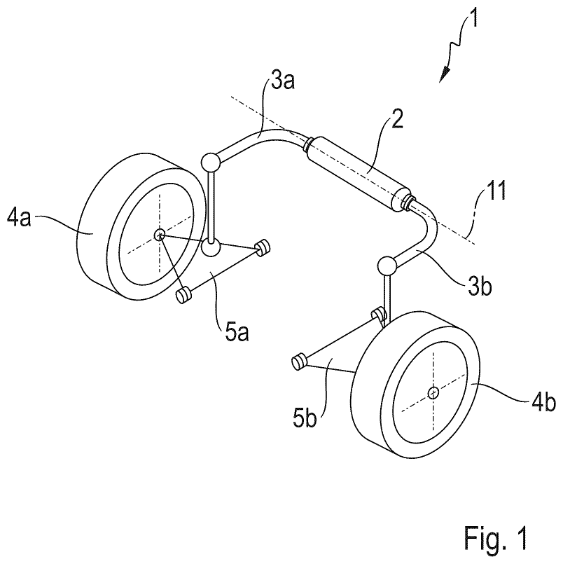

FIG. 1 shows a schematic perspective view of an adjustable roll stabilizer 1 known in its own right. The adjustable roll stabilizer 1 is an incompletely illustrated part of a chassis of a motor vehicle (not shown). The adjustable roll stabilizer 1 is part of an axle of the motor vehicle. For example, a front and/or a rear axle of the motor vehicle can be equipped with the adjustable roll stabilizer.

As shown in FIG. 1, a left-hand wheel 4a and on the opposite side of the vehicle a right-hand wheel 4b are connected by way of respective wheel suspensions 5a and 5b to a vehicle body (not shown). Thus, the wheel 4a and the wheel suspension 5a, and the wheel 4b and the wheel suspension 5b, form in each case a unit and are coupled to the respective ends of an associated stabilizer section 3a or 3b of the adjustable roll stabilizer 1. The left-hand stabilizer section 3a and the right-hand stabilizer section 3b are connected to one another centrally in the vehicle by an actuator device 2 represented in the form of an essentially cylindrical body.

In such manner, the adjustable roll stabilizer 1 is mounted to rotate relative to the vehicle body about a rotation axis 11. The actuator device 2 shown for simplicity in FIG. 1 as a cylindrical body comprises a housing which is essentially rotationally symmetrical relative to the rotation axis 11, in which housing an electric motor and a multi-stage planetary gear system drivingly connected thereto are accommodated. By way of the electric motor and the planetary gear system, the stabilizer sections 3a and 3b are in driving connection with one another. When the electric motor is idle, the two stabilizer sections 3a, 3b are connected solidly with one another via the idle electric motor and the multi-stage planetary gear system drivingly connected thereto. By operating the electric motor, depending on the rotation direction, the stabilizer sections 3a, 3b can rotate relative to one another about the rotation axis 11. That is how the roll stabilizer is adjusted, in a known manner.

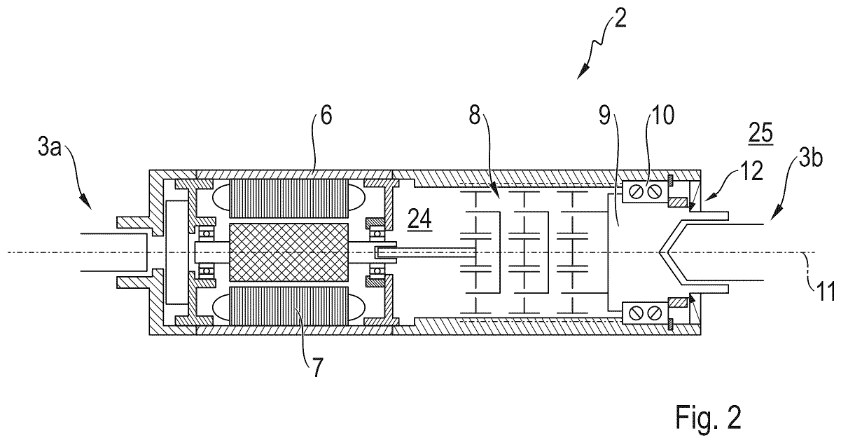

FIG. 2 shows a simplified sectioned view of an actuator device 2, which can be part of an adjustable roll stabilizer, as shown as an example in FIG. 1. The actuator device 2 comprises an essentially cylindrical housing 6 which extends concentrically relative to a rotation axis 11. At the respective ends, there are arranged a left-hand stabilizer section 3a and a right-hand stabilizer section 3b, the left-hand stabilizer section 3a being connected rotationally fixed to the housing 6 whereas the right-hand stabilizer section 3b is mounted rotatably relative to the housing. For this the right-hand stabilizer section 3b is connected to a drive output element 9, for example, welded or screwed thereto, which element is mounted to rotate about the rotation axis 11 relative to the housing 6 by virtue of a roller bearing 10.

In the housing 6 of the actuator device 2 there are also arranged an electric motor 7 and a multi-stage gear system, in this case three-stage planetary gear system 8. The electric motor 7 is drivingly connected to the three-stage planetary gear system 8 and by way of a motor drive output shaft (not shown in detail) drives a sun gear of the three-stage planetary gear system 8 associated with the first planetary stage. The three-stage planetary gear system 8 steps down a drive input rotation speed provided by the electric motor 7 to a much lower drive input rotation speed at the drive output element 9, which is a planetary carrier of the third stage of the three-stage planetary gear system 8—or at least is drivingly connected thereto. From the structure illustrated it can be seen that depending on the operational condition of the electric motor 7, the stabilizer sections 3a and 3b can be rotated relative to one another about the rotation axis 11 in order to adjust a roll stabilizer fitted with the actuator device 2 (see FIG. 1).

During the operation of the vehicle so equipped, the actuator device 2 can be exposed to wet weather such as rain or generally humid conditions. For a mechanical system such as the actuator device 2 there is then a risk that moisture will penetrate into the housing 6 of the actuator device 2 and compromise the function of components and/or damage them permanently. Accordingly, for the actuator device 2 to have a long useful life and to function reliably it is very important to seal the inside space 24 of the housing 6 reliably and durably against the external surroundings 25 of the actuator device 2. For that purpose, the actuator device 2 is provided with a seal 12.

The seal indexed 12 in FIG. 2 but not shown in any greater detail seals the inside space 24 of the actuator device 2 against its external environment 25. For that purpose, the seal 12—which is indicated only schematically in FIG. 2—is positioned axially outside the roller bearing 10 and extends all around the rotation axis 11 in an annular space between the drive output element 9 and the housing 6.

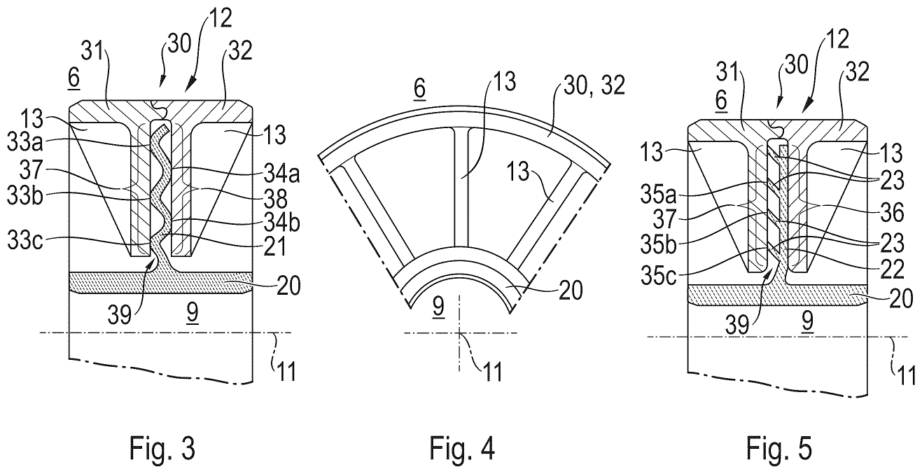

FIGS. 3 and 4 show a seal 12 according to an example embodiment of the invention, in a partial section (FIG. 3) along the rotation axis 11, and represented partially as viewed from above in the axial direction (FIG. 4). FIG. 5 shows a further (another) example embodiment of a seal 12, again as a partial view along the rotation axis 11.

The seal 12 of an actuator device, shown in FIGS. 3 and 4 as a first example embodiment of the invention, consists essentially of two components. These are an annular inner sealing element 20 associated with the drive output element 9 and an annular outer sealing element 30 associated with the housing 6. In the example embodiment shown the outer sealing element 30 consists of two annular bodies 31 and 32. The two annular bodies 31 and 32 are arranged axially close to one another and on the same axis (coaxial) with the rotation axis 11. As is clear from the drawing, they are connected to one another, namely, in this case clipped onto one another. The two annular bodies 31 and 32 have basically the same structure (in this case they are similar components) and relative to a radial separation plane of the sealing element 30 they are orientated in mirror-image relationship. In the assembled state illustrated, the outer sealing element 30 forms a circumferential groove 39 in an inward-facing all-round projection. Thus, the groove 39 is located between an all-round projection extending inward from the annular body 31 and an all-round projection extending inward from the annular body 32, and is delimited on the outside (the outer circumference) by the outer envelope surface of the sealing element 30.

The sealing element 30 that forms the circumferential groove 39 has two parallel sealing surfaces 37, 38 which are spaced axially a distance apart and face toward one another. To reinforce the all-round groove 39, a number of webs 13 are formed on the sealing element 30 which, as shown in FIG. 4, are distributed at equal angles around the periphery of the sealing element 30 and which extend in each case from an radially outer end of the second annular body 32 (and likewise from an radially outer end of the second annular body 31, which cannot be seen in FIG. 4 since it is covered) to a radially inner edge area of the second annular body 32 like spokes and in that way reinforce the two projections forming the all-round grooves 39 on the first annular body 31 and on the second annular body 32. The webs 13 have an axial depth that decreases from the radially outer area toward the radially inner area (as can be seen in FIG. 3).

The outer sealing element 30 formed by the first annular body 31 and the second annular body 32 is made of plastic. At its outer periphery the outer sealing element 30 is in contact with the housing 6, in particular being pressed against the housing 6 in the axial direction. As shown, a chamfer (or alternatively a bevel) at the axial ends of the outer sealing element 30 makes it easier to insert before being pressed in.

The annular inner sealing element 20 is made from an elastomeric plastic material and in the section shown in FIG. 3 is approximately T-shaped. The inner sealing element 20 is pressed onto the drive output element 9 along a radially inner section and rests circumferentially against it. In the axially central area of the inner sealing element 20 a membrane 21 projects radially outward, which membrane extends circumferentially around the rotation axis 11. Relative to its radial extension the membrane has an undulating shape, in that relative to a radial central plane the material of the membrane 21 rises and falls in the axial direction. The membrane 21 projects into the circumferential groove 29 of the outer sealing element 30 in the radial direction and partially fills it. At each wave peak of the membrane 21 facing toward the annular body 31 the membrane is in contact with the annular body 31 so forming, in each case, an all-round sealing area 33a, 33b, 33c. At each wave peak of the membrane 21 facing toward the annular body 32 the membrane is in contact with the annular body 32 so forming, in each case, an all-round sealing area 34a, 34b.

From the above explanation, it emerges that in an axial projection—namely, in the groove area of the circumferential groove 39—the inner sealing element 20 and the outer sealing element 30 partially overlap, and according to the example embodiment shown in FIG. 3, are contacted in a total of 5 sealing areas 33a, 33b, 33c, 34a, 34b. In the condition shown, the annular inner sealing element 20 is in a deformed state particularly in the area of the membrane 21 projecting into the circumferential groove 39, which deformation occurs because an axial width of the circumferential groove 39 is at least slightly smaller than an axial extension of the membrane 21 in its underformed state—not shown here—outside the groove 39, which compresses the membrane 21 at the opposite wave peaks.

In the assembled condition shown the membrane 21 of the inner sealing element 20 is correspondingly prestressed, whereby at the five all-round sealing areas 33a, 33b, 33c and 34a and 34b in each case a sealing force acting in the axial direction is exerted against the annular sealing surfaces 37, 38 of the first annular body 31 and the second annular body 32 respectively.

The five all-round sealing areas 33a, 33b, 33c, 34a and 34b are on axially opposite sides of the membrane 21 of the inner sealing element 20. The sealing forces of the sealing areas 33a, 33b, 33c acting in the opposite direction relative to the forces acting on the sealing areas 34a, 34b cancel out in sum. Consequently, the inner sealing element 20 and the outer sealing element 30 are free from axial reaction forces against one another, even though the seal 12 is in a prestressed condition. Thanks to the presence of the five sealing areas the entry of media through the seal 12 is prevented at five different points.

Since an actuator device fitted with a seal according to the invention as described above, particularly when used in an adjustable roll stabilizer for a motor vehicle, rotates relative to the drive output element 9 only through a comparatively small angle of rotation, in particular through a rotation angle smaller than 45° and especially smaller than 30°, there are only comparatively small paths and speeds between the sealing partners concerned. The undulating membrane 21 acts in a labyrinthine manner in the all-round groove 39 of the outer sealing element 30. A medium arriving at the inlet of the groove would have to pass through a plurality of sealing areas in order to make its way from the external surroundings 25 into the inside space 24 of the housing 6.

FIG. 5 shows a second example embodiment of the invention, namely, a seal 12 that can be used with an actuator device. This seal 12 has a structure basically similar to the seal according to the first example embodiment of the invention explained earlier with reference to FIGS. 3 and 4. Thus, to avoid repetitions only its different features will be described below.

In the seal 12 according to the second example embodiment, a membrane 22 projects outward in an axially central area of the inner sealing element 20. The membrane 22 also extends circumferentially around the rotation axis 11 and projects into an all-round groove 39 formed by the outer sealing element 30. In this case, however, the membrane 22 does not have an undulating shape (relative to its radial extension), but rather, relative to the radial direction, it extends in a straight line away from the rotation axis 11. On the membrane 22 there are formed four projections 23, each extending circumferentially around the rotation axis 11 and obliquely toward the first annular body 31 of the outer dealing element 30. Each of the all-round projections 23 contacts the sealing surface 37 of the outer sealing 30, there forming respective all-round sealing areas 35a, 35b, 35c, one for each projection 23. On the side facing toward the second annular body 32 of the outer sealing element 30 the membrane 22 rests flat against it, so as there too to form an all-round sealing area 36.

In the assembled condition shown in FIG. 5, the projections 23 are in a deformed condition that results from the fact that the axial width of the circumferential groove 39 is at least slightly smaller than the axial width of the membrane 22 in its state before fitting, i.e., outside the circumferential groove 39. The restoring forces produced by the deformation of the four projections 23 have the result that at the sealing areas 35a, 35b, 36c and 36 in each case a sealing force acting in the axial direction is exerted. Since the membrane 22 is supported on both sides in the circumferential groove 39, the sealing forces on the first annular body 31 cancel out in relation to the sealing forces on the second annular body 32, so that despite its prestressed condition the seal 12 is free from axial forces between the inner sealing element 20 and the outer sealing element 30. A chamfer in the material of the first annular body 31 and the second annular body 32 indicated at the entry point of the groove can contribute toward preventing damage to the material of the inner sealing element 20 even if the drive output element 9 moves slightly in the axial direction relative to the housing 6.

In the example embodiment shown in FIG. 5, as explained earlier the projections 23 formed on the membrane 22 extend obliquely and exclusively toward the first annular body. It should be noted that according to a design deviating from that (not shown in the drawing) it would be possible to provide the membrane 22 on both sides with projections, i.e., ones that extend not only toward the first annular body 31 but also toward the second annular body 32, which projections would then extend similarly obliquely toward the second annular body 32 and form sealing areas on the second annular body 32 by contact, so as to produce all-round sealing areas (corresponding to the sealing areas 35a, 35b and 35c). Relative to a radial plane extending through the membrane these could be made symmetrically in the sense that the same number of similarly designed projections are present on each side of the membrane.

All-in-all, with the actuator device according to the example embodiments shown, a possibility for sealing the housing is provided, which, even under the action of high mechanical loading—that results in translation and/or rotation position changes of the drive output element—ensures reliable sealing of the actuator device throughout its useful life. By virtue of the axial sealing principle, position changes of the drive output element can be compensated, while at the same time the comparatively simple design principle of the groove and membrane ensures that production is simple.

### INDEXES

1 Adjustable roll stabilizer
2 Actuator device
3a, 3b Stabilizer sections
4a, 4b Wheel
5a, 5b Wheel suspension
6 Housing
7 Electric motor
8 Multi-stage planetary gear system
9 Drive output element
10 Roller bearing
11 Rotation axis
12 Seal
13 Web
20 Inner sealing element
21 Membrane
22 Membrane
23 Projections
24 Inside space
25 External environment
30 Outer sealing element
31 First annular body
32 Second annular body
33a-c All-round sealing area
34a-b All-round sealing area
35a-c All-round sealing area
36 All-round sealing area
37 Sealing surface
38 Sealing surface
39 Circumferential groove

1. An actuator device (2) for a roll stabilizer of a motor vehicle, the actuator device comprising:
a housing (6);
a drive output element (9) mounted to rotate relative to the housing about a rotation axis (11);
a seal (12) associated with the drive output element and configured for sealing an inside space (24) of the housing (6) relative to an external environment (25) wherein the seal (12) comprises an annular inner sealing element (20) associated with the drive output element; and and an annular outer sealing element (30) associated with the housing, wherein, in an axial projection, the inner sealing element partially overlaps and contacts the outer sealing element (30) so as to form at least one all-round sealing area (33a, 33b, 33c, 34a, 34b; 35a, 35b, 35c, 36).

2. The actuator device (2) according to claim 1, wherein in the all-round sealing area (33a, 33b, 33c, 34a, 34b; 35a, 35b, 35c, 36) the inner sealing element (20) and the outer sealing element (30) exert a sealing force on one another, which acts in an axial direction.

3. The actuator device (2) according to claim 1, wherein one of the inner sealing element (20) or the outer sealing element (30) has at least one annular sealing surface (37, 38) that extends in a radial direction.

4. The actuator device (2) according to claim 1, wherein the sealing force is produced by a prestress, which is applied by virtue of a partial deformation of one of the inner sealing element (20) or the outer sealing element (30).

5. The actuator device (2) according to claim 1, wherein the inner sealing element (20) contacts the outer sealing element (30) so as to define multiple circumferential sealing areas (33a, 33b, 33c, 34a, 34b; 35a, 35b, 35c, 36).

6. The actuator device (2) according to claim 1, wherein one of the outer sealing element (30) or the inner sealing element (20) defines a circumferential groove (39), into which the other of the inner sealing element (20) or the outer sealing element (30) projects radially and partially.

7. The actuator device (2) according to claim 6, wherein the inner sealing element (20) or the outer sealing element (30) defining the circumferential groove (39) has two sealing surfaces (37, 38) parallel to one another and spaced axially a distance apart from one another.

8. The actuator device (2) according to claim 6, wherein the inner sealing element (20) or the outer sealing element (30) that defines the circumferential groove (39) has a plurality of sealing areas (33a, 33b, 33c, 34a, 34b; 35a, 35b, 35c, 36).

9. The actuator device (2) according to claim 6, wherein one of the inner sealing element (20) or the outer sealing element (30) comprises two adjacent annular bodies (31, 32) arranged coaxially relative to the rotation axis (11), the annular bodies shaped such that between them an annular space forming the circumferential groove (39) is produced.

10. The actuator device (2) according to claim 9, wherein the annular bodies (31, 32) are connected to one another with interlock or by friction.

11. The actuator device (2) according to claim 9, wherein the annular bodies (31, 32) are identical components orientated in a mirror-image relationship relative to a radial plane of separation.

12. The actuator device (2) according to claim 6, wherein the claim 6, wherein the inner sealing element (20) or the outer sealing element (30) that projects into the circumferential groove (39) is made from an elastomeric material.

13. The actuator device (2) according to claim 6, wherein the inner sealing element (20) or the outer sealing element (30) that projects into the circumferential groove (39) has, in part, an undulating shape relative to its radial extension, in order to form at each wave peak an all-round sealing area (33a, 33b, 33c, 34a, 34b).

14. The actuator device (2) according to claim 6, wherein the inner sealing element (20) or the outer sealing element (30) that projects into the circumferential grove (39) has the same number of all-round sealing areas (33a, 33b, 33c, 34a, 34b) on opposite axial sides.

15. The actuator device (2) according to claim 6, wherein the inner sealing element (20) or the outer sealing element (30) that projects into the circumferential grove (39) defines an all-round projection (23)

16. The actuator device (2) according to claim 1, wherein the housing (6) has a cylindrical shape and is configured to accommodate a drive unit comprising an electric motor (7) and a multi-stage planetary gear system (8), which can be brought into driving connection with the drive output element (9).

17. A seal (12) for an actuator device (2) of a motor vehicle having a housing and a drive output element (9) mounted to rotate relative to the housing about a rotation axis, the seal comprising:
an annular outer sealing element (30) adjacent the housing;
an annular inner sealing element (20) adjacent the drive output;
wherein the inner and outer sealing elements (20, 30) are configured to be arranged coaxially with a rotation axis (11) of the drive output element (9) of the actuator device (2), and wherein one of the inner and outer sealing elements (20, 30) defines an axial projection that partially overlaps the other of the inner and outer sealing elements, and wherein the inner and outer sealing elements are in contact so as to form at least one all-round sealing area ((33a, 33b, 33c, 34a, 34b; 35a, 35b, 35c, 36).

18. The actuator device (2) according to claim 9, wherein the annular bodies (31, 32) are clipped to one another.
